(19) United States
(12) Patent Application Publication
(10) Pub. No.: US 2025/0329764 A1
(43) Pub. Date: Oct. 23, 2025

(54) METHOD FOR OPERATING A FUEL CELL SYSTEM, AND CONTROL DEVICE

(71) Applicant: Robert Bosch GmbH, Stuttgart (DE)

(72) Inventors: Christophe Gerling, Filderstadt (DE); Matthias Martin Hanauer, Leonberg (DE); Ulrich Sauter, Karlsruhe (DE); Ulrich Berner, Stuttgart (DE)

(21) Appl. No.: 18/864,103

(22) PCT Filed: May 9, 2023
(86) PCT No.: PCT/EP2023/062166

§ 371 Date: Nov. 19, 2024

(30) Foreign Application Priority Data
May 9, 2022 (DE) 10 2022 204 532.7

(51) Int. Cl. H01M 8/0662; B60R 16/033; H01M 8/04223; H01M 8/04228; H01M 8/04746; H01M 8/04858

(52) U.S. Cl. CPC H01M 8/0662; H01M 8/04228; H01M 8/04231; H01M 8/04753; H01M 8/0488; B60R 16/033; H01M 2250/20

(57) ABSTRACT

The invention relates to a method for operating a fuel cell system comprising a fuel cell stack having an anode and a cathode, in which the following steps for oxidizing impurities present in the anode, in particular adsorbates, are performed:
S1 Interrupt the supply of air to the cathode of the fuel cell stack and ramp down the cell voltage by electrochemically reducing residual oxygen present in the cathode,
S2 Interrupt the supply of hydrogen to the anode and electrochemically pump residual hydrogen present in the anode to the cathode, and
S3 Oxidize the impurities by increasing the anode potential.

The invention also relates to a control device for carrying out steps of the method according to the invention.

### BACKGROUND

The invention relates to a method for operating a fuel cell system having the features of the disclosure. The invention furthermore relates to a control device for carrying out steps of the method.

Preferred areas of application are mobile fuel cell systems and/or fuel cell vehicles.

Fuel cells are electrochemical energy converters. In particular, hydrogen (H₂) and oxygen (O₂) can be used as reaction gases. These are converted into electrical energy, water (H₂O), and heat with the aid of a fuel cell. In practice, a large number of fuel cells are connected to form a fuel cell stack in order to increase the electrical output. A plurality of channels permeate through the stack, namely supply channels for supplying the individual fuel cells with the required media as well as disposal channels for the removal of consumed and depleted media.

The core of a fuel cell is the membrane electrode assembly (MEA). The core of a fuel cell is a membrane which is coated on both sides with a catalytic material to form electrodes. The electrodes or catalyst layers typically consist of platinum particles applied to larger carbon particles. While the platinum particles form the catalyst, the carbon phase provides electron and heat transport. In addition, the catalyst layers are typically permeated by an ionomer to ensure proton conductivity. The concurrence of platinum, ionomer and reactant results in three phase boundaries that are required for the electrochemical reaction.

On the anode side, at the three-phase boundaries catalyzed by the platinum particles, oxidation from hydrogen to protons and electrons takes place according to the equation H₂=2H⁺2e⁻. One drawback associated with the use of platinum as a catalyst is the very low tolerance to carbon monoxide poisoning, which can occur due to the use of impure hydrogen. In this case, carbon monoxide is adsorbed on the active platinum surfaces, blocking not only the hydrogen reaction to the platinum sites occupied by carbon monoxide, but also reducing the activity of the free platinum sites.

In practice, this poisoning mechanism is slowed down by oxygen permeation from the cathode side to the anode side of the fuel cell. However, this assumes that the concentration of hydrogen impurity is in an acceptable range. If this is the case, the oxygen permeation flow is sufficient to oxidize parasitic carbon monoxide in the anode electrode and keep the anode electrode free of carbon monoxide adsorbates. However, if the concentration of the impurity exceeds the acceptable range, the oxygen permeation flow will no longer be sufficient, causing the performance of the anode to decrease over time.

To counter this, anode-side catalysts may be used that have a higher tolerance to carbon monoxide poisoning compared to platinum. These catalysts include platinum binary alloys, such as PtRu, PtSn, PtRh, PtMo, PtNi, PtFe, PtIr, and other ternary alloys. By using a corresponding catalyst, the oxidation potential may be reduced and/or the adsorption capacity of carbon monoxide reduced. The actual cleaning step is then carried out by an anode-side potential increase, for example by load pulses. However, one disadvantageous aspect is that further problems can arise, for example, physical chemical instability and a faster degradation of the fuel cell associated with this, lower power output and higher costs.

Alternatively, the use of ultrapure hydrogen may be provided. However, this approach often fails due to the high cost and/or unavailability of ultrapure hydrogen.

### SUMMARY

The present invention deals with the task of eliminating or at least minimizing the drawbacks described above in the operation of a fuel cell system. The focus is not only on carbon monoxide adsorbates, but also on other harmful adsorbates that cover the catalyst surface and can thus block the catalytic reaction. In addition to carbon monoxide, these include, for example, sulfur as well as sulfur compounds, hydrocarbons and/or nitrogen oxides.

In order to solve this problem, the method having the features of the disclosure is proposed. In addition, a control device for carrying out steps of the method is proposed.

A method of operating a fuel cell system comprising a fuel cell stack with a cathode and an anode is proposed. In the method, the following steps are carried out for oxidizing impurities present in the anode, in particular adsorbates:
S1 Interrupt the supply of air to the cathode of the fuel cell stack and ramp down the cell voltage by electrochemically reducing residual oxygen present in the cathode,
S2 Interrupt the supply of hydrogen to the anode and electrochemically pump residual hydrogen present in the anode to the cathode, and
S3 Oxidize the impurities by increasing the anode potential.

With the aid of the proposed method, not only carbon monoxides but also other parasitic adsorbates that cover the particles contained in the anode-side catalyst layer made of platinum or a platinum alloy can be oxidized and removed from the anode. They are removed by rinsing them out, no later than when the fuel cell system resumes normal operation.

No additional components are needed to carry out the method. Further, platinum or a platinum alloy may also be used as a catalyst. In addition, there is no need to evaluate the degree of purity of the hydrogen available.

An important method step is increasing the anode potential in step S3. Depending on the impurity to be oxidized, the anode potential to be achieved may vary. Carbon monoxide adsorbed on platinum may, for example, be oxidized at potentials of between 0.6 V and 0.8 V. For sulfur compounds and nitrogen oxides, potentials above 0.8 V or even above 0.9 V are required.

Preferably, therefore, in step S3, the anode potential is increased to 0.4 V to 1.5 V, preferably to 0.6 V to 1.0 V, particularly preferably to 0.8 V, compared to the cathode potential.

All potentials indicated are stated relative to the normal hydrogen electrode. Stated voltages always refer to single cells and are defined as cathode potential minus anode potential (relative to the configuration in normal operation of a fuel cell).

Such a high anode potential is usually not achieved—without further measures—because the equilibrium potential of the anode half cell is around 0 V.

Further therefore, preferably, in step S3, the anode potential is increased by a potential jump, a potential ramp, or a cyclic potential ramp. If there is a potential jump, it is increased in stages. In a cyclic potential ramp, also called cyclic voltammetry, the cell voltage is cycled between 0 V and −1.0 V, for example in one to four cycles at rates between 10 mV/s and 500 mV/s.

Steps S1 to S3 can be performed at regular intervals, for example according to a predefined recovery protocol. The intervals can be adjusted depending on the impurity of the hydrogen. Conducting the method at regular intervals presumes the presence of a buffer battery or additional fuel cell stack with sufficient capacity or performance to replace the electrical power of the affected fuel cell stack while the method is being carried out.

If no buffer battery or additional fuel cell stack is present to cover the power demand, steps S1 to S3 may also be performed while shutting down the fuel cell system. This is because, when shutting down, a so-called “oxygen bleed down” (also known as “air starve”) is usually carried out, in which the voltage of the fuel cell stack is reduced by electrochemically reducing the residual oxygen in the cathode. Accordingly, the measures specified in step S1 of the proposed method are already carried out when shutting down, so that only steps S2 and S3 must subsequently be carried out.

Steps S1 and S2 do not necessarily have to be carried out one after the other. They can also be run simultaneously or during overlapping time periods.

To interrupt the air supply in step S1, valves arranged in the area of the inlet and the outlet of the fuel cell stack in an air system of the fuel cell system are preferably closed first. Then the cell voltage may be decreased.

The reduction of the cell voltage in step S1 is preferably forced by power tapping. The power may further be fed into the vehicle system and/or a battery, in particular the buffer battery of the fuel cell system.

The hydrogen supply is interrupted no later than after the cell voltage has been switched off to perform step S2. Hydrogen is still present in the anode, while only nitrogen and water are present in the cathode. The hydrogen present in the anode is then electrochemically pumped to the cathode side.

Preferably, in step S2, the electrochemical pumping is effected by applying a current and/or a voltage. The voltage becomes negative as a result. Due to the hydrogen present in the cathode, the cathode forms a reference and counter electrode. Even very small amounts of hydrogen on the cathode side are already sufficient to obtain a good reference or counter electrode. That is, the full amount of hydrogen that is still present on the anode side does not need to be pumped to the cathode side. However, the electrical currents in step S3 of the method increase with the residual amount of hydrogen on the anode side. A particularly preferred embodiment therefore consists of reducing the residual amount of hydrogen by interrupting hydrogen supply at a suitable time during step 1. The time must be selected such that the amount of hydrogen in the anode path is still sufficiently high to ensure complete conversion of the remaining amount of oxygen.

In step S3, the anode potential is then increased, for example by cyclic voltammetry, by one or more cell voltage ramps, or by one or more cell voltage jumps, to oxidize the adsorbate or adsorbates, respectively.

In the simplest embodiment, in step S3 the voltage of the entire stack is adjusted via the end plates. A single cell voltage monitoring (CVM) can be used to ensure that no cell voltage exceeds a predetermined maximum value (for example 1 V). In an alternative embodiment, in step S3, a controlled voltage is applied to each single cell of the stack, either simultaneously, sequentially, or bundled. The connections of a single cell monitoring can be used to tap differential currents of individual cells.

Depending on the amount of hydrogen on the cathode side, normal operation of the fuel cell system may be continued after step S3 without the need to take other measures first. This is in particular the case if only small amounts of hydrogen are present on the cathode side.

Alternatively, after performing steps S1 through S3, hydrogen present in the cathode may be pumped back to the anode before continuing normal operation of the fuel cell system.

In normal operation of the fuel cell system, the oxidized adsorbate is simply flushed out.

In addition, a control device that is configured so as to carry out steps of a method according to the invention is proposed. A recovery protocol can be stored in the control unit, for example, according to which the method is carried out at regular intervals or when the fuel cell system is switched off.

### BRIEF DESCRIPTION OF THE DRAWINGS

The invention and its advantages are explained in more detail below with reference to the accompanying drawings. Shown are:

FIG. 1 a flow diagram for depicting a preferred procedure of the method according to the invention, and

FIG. 2 a cyclic voltammogram of a Pt/C electrode poisoned by carbon monoxide.

### DETAILED DESCRIPTION

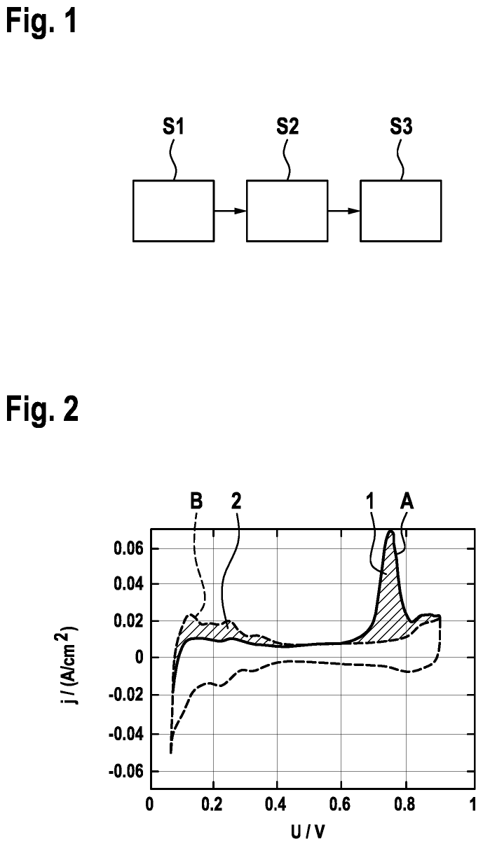

The sequence shown in FIG. 1 comprises three steps, from S1 to S3, as an example.

In step S1, the supply of air to the cathode is initially interrupted by closing the valves at the inlet and outlet of the fuel cell stack so that a self-contained volume of oxygen remains on the cathode side. Then, by power tapping, the fuel cell reaction is further forced to reduce oxygen and bring the cell voltage below 0.2 V, preferably below 0.1 V, particularly preferably below 0.05 V.

In the following step 2, which can also be carried out simultaneously or at least during a time period overlapping with step S1, the hydrogen supply to the anode is first interrupted. Subsequently, the hydrogen present in the anode is introduced to the cathode side by electrochemical pumping.

In step S3, the oxidation of the parasitic adsorbate then takes place by increasing the anode potential, for example by a potential jump or by a cyclic potential ramp, also called cyclic voltammetry.

Carbon monoxide oxidation by cyclic voltammetry is depicted in the graph of FIG. 2 as an example, wherein curve A is attributable to a first cycle and curve B is attributable to a second cycle. Region 1 shows an oxidation peak. Region 2 shows the gain in active platinum surface after the first cycle.

1. A method of operating a fuel cell system comprising a fuel cell stack having an anode and a cathode, in which the following steps are performed for oxidizing impurities present in the anode, the method comprising:
(step S1) interrupting a supply of air to the cathode of the fuel cell stack and ramping down a cell voltage by electrochemically reducing residual oxygen present in the cathode,
(step S2) interrupting a supply of hydrogen to the anode and electrochemically pumping residual hydrogen present in the anode to the cathode, and
(step S3) oxidizing impurities by increasing the anode potential.

2. The method according to claim 1,
wherein in step S3 the anode potential is increased to 0.4 V to 1.5 V, compared to the cathode potential.

3. The method according to claim 1,
wherein in step S3 the anode potential is increased by a potential jump, a potential ramp or a cyclic potential ramp.

4. The method according to claim 1, wherein steps S1 to S3 are performed at regular time intervals.

5. The method according to claim 1, wherein steps S1 to S3 are performed when shutting down the fuel cell system.

6. The method according to claim 1, wherein steps S1 and S2 are performed simultaneously or during overlapping time periods.

7. The method according to claim 1, wherein in step S1 the reduction in the cell voltage is forced by power tapping and the power is fed into the vehicle system and/or a battery.

8. The method according to claim 1, wherein in step S2, the electrochemical pumping is effected by applying a current and/or a voltage.

9. The method according to claim 1, wherein after performing steps S1 to S3 hydrogen present in the cathode is pumped back to the anode before continuing normal operation of the fuel cell system.

10. A control device configured to operating a fuel cell system comprising a fuel cell stack having an anode and a cathode, by controlling:
interruption of a supply of air to the cathode of the fuel cell stack and ramping down of a cell voltage by electrochemically reducing residual oxygen present in the cathode,
interruption of a supply of hydrogen to the anode and electrochemically pumping of residual hydrogen present in the anode to the cathode, and
oxidization of impurities by increasing the anode potential.
